(19) United States
(12) Patent Application Publication
(10) Pub. No.: US 2003/0043579 A1
(43) Pub. Date: Mar. 6, 2003

(54) Decorative lighting string

(76) Inventors: Zhu Jian Rong, San Gabriel, CA (US); Zhu Weibing, Taizhou City (CN)

Correspondence Address: Russell J. Egan, Suite 120, 908 Town & Country Blvd., Houston, TX, 77024-2221, US

(21) Appl. No.: 09/943,310

(22) Filed: Aug. 31, 2001

(51) Int. Cl. F21S 4/00; F21V 1/00

(52) U.S. Cl. 362/237; 362/236; 362/351; 362/806

(57) ABSTRACT

An array of distinctively shaped translucent members are selectively placed on LED lamps of a decorative light string to create a novel display. Each member is made of a flexible translucent plastic material having a distinctive shape and a recess for receiving the LED bulb. The shape of the members include, but are not restricted to, flowers or other objects from nature, religious or national symbols, astronomical or zodiac objects and symbols, geometric shapes, and depictions of structures such as historical buildings.

### BACKGROUND OF THE INVENTION

1. The Field of the Invention

The present invention relates to a decorative lighting string and, in particular, to a lighting string which can provide a distinctive and changeable display.

2. The Prior Art

During festival season, it is a widely accepted custom to decorate dwellings and grounds with decorative lighting. Traditionally this was accomplished by strings of lights, each light bulb received in a separate socket. In earlier versions of these strings of lights, the bulbs were wired in series so that when one bulb burned out, the entire string went dark. Later strings of lights were wired in parallel to overcome this disadvantage but they were still subject to bulbs burning out and were limited to the number of bulbs in a string and stings strung together. This problem was addressed by the newer miniature bulbs which consumed less power allowing greater lengths of strings to be strung together. The miniature bulbs were replaced by LEDs allowing even greater lengths of light strings. Each of these advancements overcame a previous problem and created a newer problem. Now it is possible to have substantial lengths of light strings, but he is the problem of sameness in the lights creating a less than distinctive appearance for the display. Examples of this type of lighting string, using LEDs, may be found in U.S. Pat. Nos. 5,887,967 to Chang and 6,066,004 to Shen. It is also known to encapsulate LEDs in flexible tubing to form decorative light strings, as shown in U.S. Pat. Nos. 3,755,663 and 4,271,458 to George and 4,607,317 to Lin. It is also known to have controls for light strings for blinking the lights is various sequences. Such controls are shown in U.S. Pat. Nos. 4,780,621 to Bartleucci et al; 5,495,147 to Lanzisera; and 6,072,280 to Allen. It is further known to cover individual bulbs with decorative covers, such as shown in U.S. Pat. Nos. 5,361,192 to Lai; 5,918,967 to Land; 6,059,430 to Chen, and Designs 182,034 to Bossi and U.S. Pat. No. 429,351 to Grether; light shields, such as shown in U.S. Pat. No. 5,951,148 to Limber.

It is therefor an object of the present invention to create a decorative light string in which the individual lights can be fitted with a distinctive cover thereby creating a new and novel decorative display which can be seasonal and/or topical in nature.

### SUMMARY OF THE INVENTION

An array of distinctively shaped translucent members are selectively placed on LED lamps of a decorative light string to create a novel display. Each member is made of a flexible translucent plastic material having a distinctive shape and a recess for receiving the LED bulb. The shape of the members include, but are not restricted to, flowers or other objects from nature, religious or national symbols, astronomical or zodiac objects and symbols, geometric shapes, and depictions of structures such as historical buildings.

### BRIEF DESCRIPTION OF THE DRAWINGS

The present invention will now be described, by way of example, with reference to the accompanying drawings, in which:

FIG. 1 is an exploded side elevation, partially in section, of a first embodiment the subject invention;

FIG. 2 is an exploded detailed view, partially in section, of the lamp assembly according to the present invention;

FIG. 3 is a side elevation, partially in section, of the assembled heart shaped first embodiment of the subject invention;

FIG. 4 is a side elevation, partially in section, of an assembled flower shaped second embodiment of the subject invention;

FIG. 5 is a side elevation, partially in section, of an assembled tree shaped third embodiment of the subject invention;

FIG. 6 is a side elevation, partially in section, of an assembled moon shaped fourth embodiment of the subject invention;

FIG. 7 is a side elevation, partially in section, of an assembled star shaped fifth embodiment of the subject invention;

FIG. 8 is a side elevation, partially in section, of an assembled diamond shaped sixth embodiment of the subject invention;

FIG. 9 is a side elevation, partially in section, of an assembled geometric shaped seventh embodiment of the subject invention; and

FIG. 10 is a side elevation, partially in section, of an assembled house shaped eighth embodiment of the subject invention;

### DETAILED DESCRIPTION OF THE INVENTION

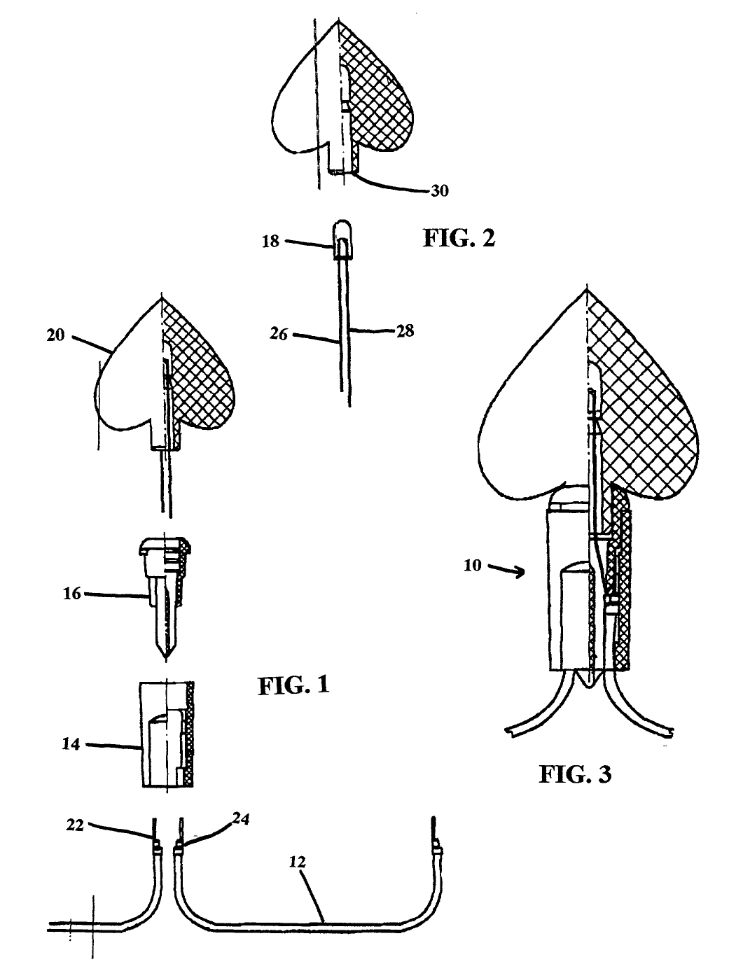

Turning first to FIGS. 1 to 3, the present invention has a plurality of light units 10 spaced along wires 12 with each unit having a base 14, a bulb holder 16, a LED 18, and a lamp cover member 20. Terminals 22, 24 on wires 12 contact the leads 26, 28 of the LED 18. Each lamp cover member is made of a flexible translucent plastic material, such as PVC, and includes a lamp receiving bore 30.

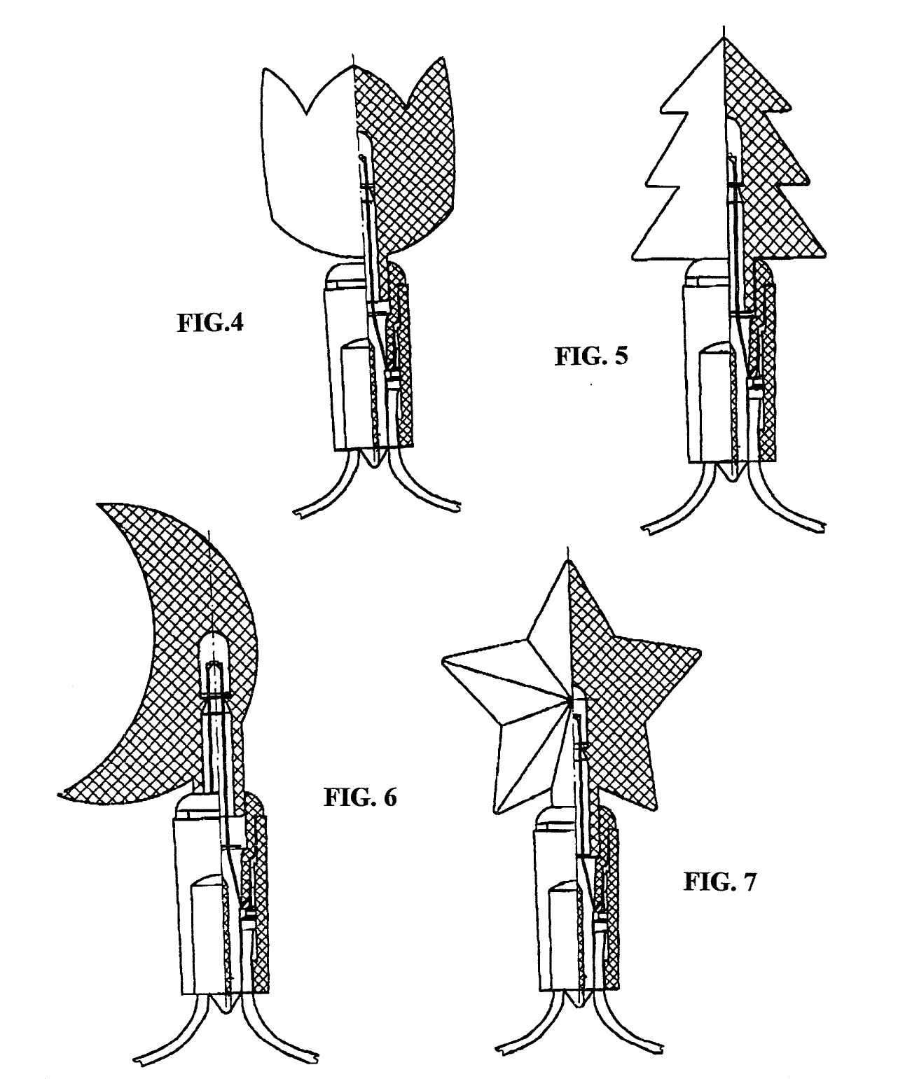

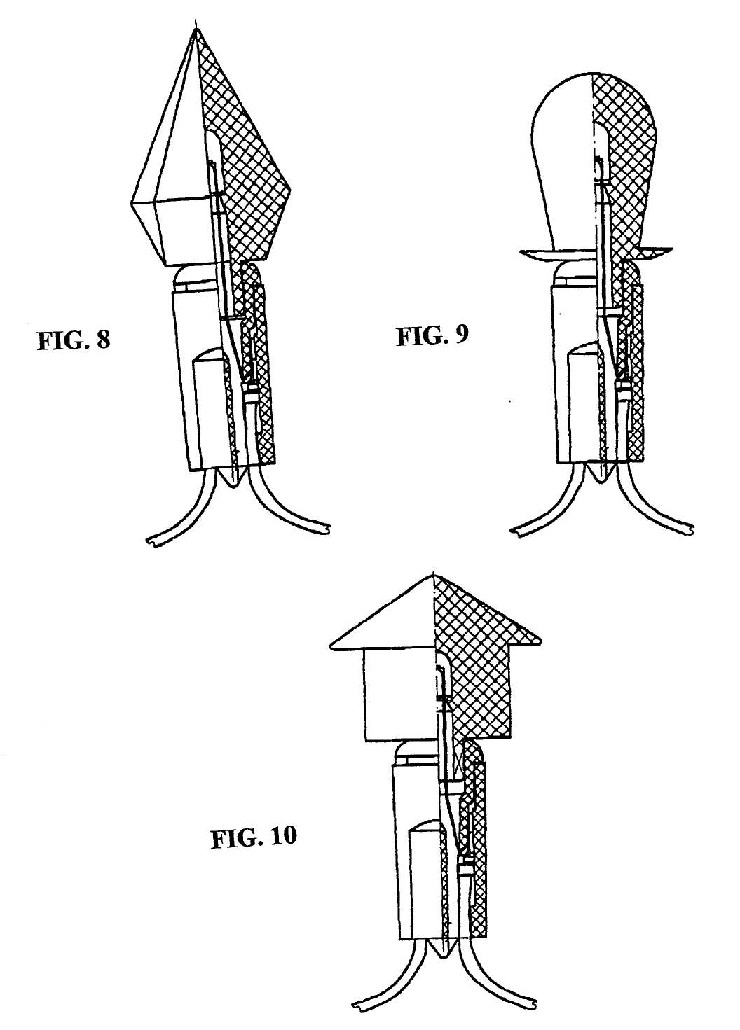

The cover members may have any of a variety of external profiles including, but not restricted to a heart shape (FIGS. 1 to 3), flower, plant or tree shape (FIGS. 4 and 5); an astronomical or zodiac shape or symbol (FIGS. 6 and 7), a diamond or other geometric shape (FIGS. 8 and 9), or a house or building shape (FIG. 10).

The cover member must be at least translucent, but they may also be tinted in various hues to accentuate the light, when illuminated, as well as to present a more pleasing appearance when not illuminated.

The present invention may be subject to a wide variety of changes and modifications without departing from the spirit of essential characteristics of the present invention as defined by the appended claims. The foregoing description should therefor be considered in all respects as illustrative of the subject invention as defined by the appended claims.

We claim:

1. In combination with a decorative light string having a plurality of LED lights, an array of distinctively shaped translucent cover members to be selectively placed on said LED lights to create a novel display, each said cover member being made of a flexible translucent plastic material having a distinctive shape and a recess for receiving the LED light therein.

2. The combination according to claim 1 wherein:
said cover members are shaped as flowers and other objects from nature.

3. The combination according to claim 1 wherein:
said cover members are shaped as religious or national symbols.

3. The combination according to claim 1 wherein:
said cover members are shaped as astronomical and zodiac objects and symbols.

4. The combination according to claim 1 wherein:
said cover members are shaped as geometric shapes.

5. The combination according to claim 1 wherein;
said cover members are shaped as depictions of structures such as historical buildings.
